(19) United States
(12) Patent Application Publication
(10) Pub. No.: US 2005/0042384 A1
(43) Pub. Date: Feb. 24, 2005

(54) Method of altering the frequency of blades for thermal fluid-flow machines

(76) Inventors: Bruno Benedetti, Wettingen (CH); Andreas Kieninger, Nussbaumen (CH); Christoph Nagler, Zuerich (CH); Joerg Stengele, Ruetihof (CH)

Correspondence Address: CERMAK & KENEALY LLP, P.O. BOX 7518, ALEXANDRIA, VA, 22307, US

(21) Appl. No.: 10/892,278

(22) Filed: Jul. 16, 2004

Related U.S. Application Data
(63) Continuation of application No. PCT/CH03/00022, filed on Jan. 16, 2003.

(30) Foreign Application Priority Data
Jan. 22, 2002 (CH) 2002 0104/02

(51) Int. Cl. B05D 1/08

(52) U.S. Cl. 427/446

(57) ABSTRACT

A method of altering the frequency of blades (1) having an airfoil (2) with a suction side (6), a pressure side (5), a leading edge (10), a trailing edge (7) and a blade tip (9), and including a blade root (3), in particular turbine blades, for thermal fluid-flow machines. A metallic coating (8) formed of a material identical to the parent material is applied to the blade (1), already ready for use, in the region of the blade tip (9), the thickness of the coating (8) tapering continuously at the trailing edge (7) and in the radial direction toward the blade root (3).

This application is a Continuation of, and claims priority under 35 U.S.C. § 120 to, International application number PCT/CH03/00022, filed Jan. 16, 2003, and claims priority under 35 U.S.C. § 119 to Swiss application number 2002 0104/02, filed Jan. 22, 2002, the entireties of both of which are incorporated by reference herein.

### BACKGROUND OF THE INVENTION

1. Field of the Invention

The invention relates to the field of thermal fluid-flow machines. It relates to a method of altering the frequency of blades, in particular turbine blades, which are already largely ready for use for fitting in the fluid-flow machine.

2. Brief Description of the Related Art

The output of a gas turbine is essentially determined by the processed mass flows such as fuel and air.

In addition to the seals, bearings, etc., in particular the quality of the blading has an effect on the efficiency level of a gas turbine. The blade dimensions, e.g. the chord length, the blade height, the arching, the profile, the twist and the blade spacing, determine the flow data of a stage which are the most suitable for the turbine, for example entry and exit angle, pressure ratio, gas speed and quantity.

The design/construction of a new gas turbine is nowadays based on experience, calculations and tests. In the process, there are always parameters which, due to assumptions, only inadequately constitute the optimum.

Differences between the theoretical frequency calculation during the design phase and the measured frequency require an alteration of the blade frequency on the finished blade in order to prevent the failure of components during operation of the machine on account of resonance excitation.

If sufficient time is available, the frequency at the blades can be altered using diecast wax patterns. In the case described above, this solution is of no use, since the components are already ready for use in the turbine, so that, for cost reasons, a very quick method of altering the frequency at the blades is necessary.

It is known from repair practice to apply material by means of flame spraying in the case of plain bearings, rollers, cylinders, etc. After resurfacing by grinding, these parts are serviceable again and are equal to new parts. Here, it is a matter of reproducing the original mass or of applying materials which are more resistant to wear.

It is also known to apply material to certain components by means of welding. However, this requires the availability of weldable materials. Before the components are used, they must likewise be resurfaced by grinding.

It is known from EP 1 026 366 A1 to apply a material coating in the region of the blade tip/trailing edge of a turbine blade in order to dampen vibrations, in which case, for example, plasma spraying or other physical or chemical vapor deposition methods are used. The thickness of the coating, which consists of a bonding layer of metal or of a metal/rare-earth complex and of an oxide ceramic layer applied thereto, is varied over the surface of the blade in order to achieve an optimum damping effect. If the outer ceramic layer is subjected to vibrations, viscous shearing occurs in the ductile bonding layer, so that the amplitude of the vibrations is reduced.

### SUMMARY OF THE INVENTION

The aim of the invention is to avoid said disadvantages of the prior art. The object of the invention is to develop a method of altering the frequency of blades, in particular turbine blades, which can be used quickly and simply in the case of blades which are already ready for use. On account of the high aerodynamic sensitivity of the blades, the changes in the airfoil profile are to be only very small.

According to the invention, this object is achieved in that a metallic coating consisting of a material identical to the parent material is applied to the blade, already ready for use, in the region of the blade tip, the thickness of the coating tapering continuously at the trailing edge and in the radial direction toward the blade root.

The advantages of the invention consist in the fact that it is possible with the method according to the invention to alter the frequency very quickly in turbine blades which have differences between the theoretical frequency calculation during the design phase and the frequency actually measured. As a result, failure of the components during operation of the machine as a result of resonance excitation can be prevented.

It is advantageous if the metallic coating is applied to the airfoil by means of a flame spraying process. The flame spraying process can be used in a relatively universal manner. Material thicknesses can be realized within relatively wide ranges.

In addition, smooth continuous transitions can be achieved in the deposit thickness, in the course of which the deposit material can be placed at the correct locations in a localized manner without appreciable rework being necessary, e.g. resurfacing by grinding.

### BRIEF DESCRIPTION OF THE DRAWINGS

An exemplary embodiment of the invention is shown in the drawing, in which:

FIG. 1 shows a side view of a gas turbine blade, and

FIG. 2 shows a section along line II-II in FIG. 1.

### DETAILED DESCRIPTION OF THE PREFERRED EMBODIMENTS

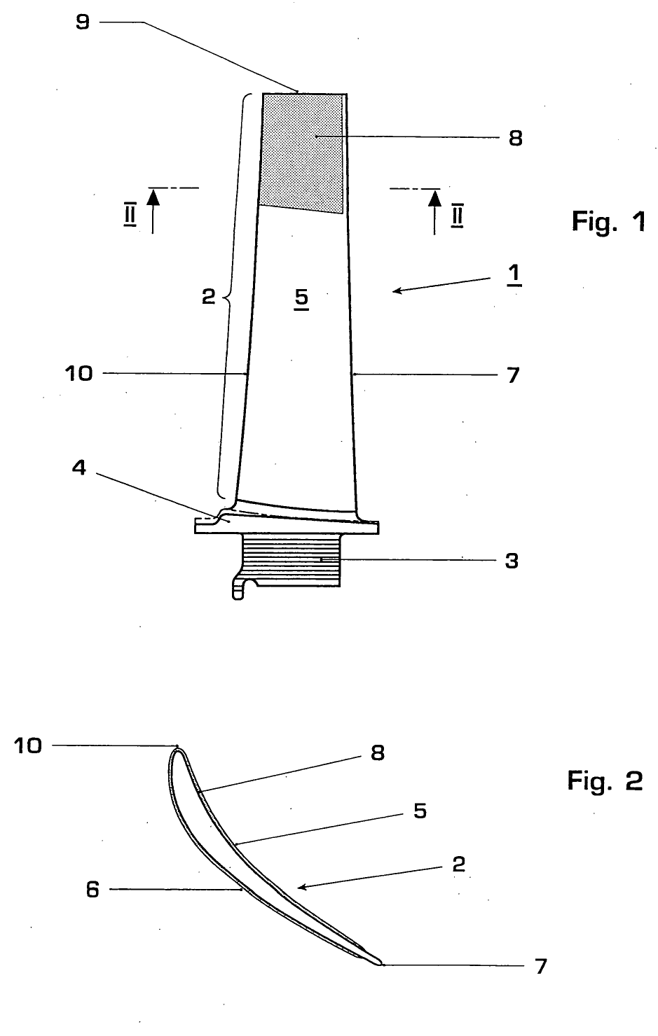

The invention is explained in more detail below with reference to an exemplary embodiment and FIGS. 1 and 2.

FIG. 1 shows a moving blade 1 of a gas turbine in side view. The moving blade 1 consists of an airfoil 2, a blade root 3 and a platform 4 which is arranged in between and from which the airfoil 2 extends in an integral manner. The blade root 3 serves to fasten the turbine blade 1 in a turbine rotor (not shown). The airfoil 2 has a pressure side 5 and a suction side 6 (not visible in FIG. 1), which adjoin one another at a trailing edge 7, and a blade tip 9. The view of the pressure side 5 of the airfoil 2 is shown in FIG. 1.

FIG. 2 shows a section along the plane II-II of FIG. 1. For reasons of simplification, the inner contour of the blade 1, which has an internal cooling system, is not shown in FIG. 2.

In order to remove frequency differences between the frequency theoretically calculated during the design phase and the frequency actually measured on the blade 1 ready for use and thereby prevent resonance excitation, the airfoil 2 ready for use per se is provided according to the invention with a metallic coating 8 at the blade tip 9 before fitting. The coating 8 consists of a material identical to the parent material. The metal in this case is preferably applied to the airfoil 2 by means of a flame spraying process known per se. It is important that the thickness of the metallic coating 8 tapers continuously at the trailing edge 7 and in the radial direction toward the blade root 3.

In the concrete case, the procedure for a blade which consisted of the parent material IN738LC was as follows:
By tests in the continuous frequency test stand, a setpoint value was determined by the factor df/dm (frequency change as a function of the additional mass) being determined by means of small mass pieces which were adhesively bonded to the blade tip. Of course, this factor could also be determined by means of a calculation.
On the basis of the admissible frequency band and the actual values measured, it turned out that, in the concrete case, the natural frequency had to be reduced by 7 Hz.
From the value df/dm and the setpoint selection for reducing the natural frequency by 7 Hz, the mass to be applied to the blade tip was calculated as 23 g. This corresponds to a material volume of 2.8 cm³ for IN738LC (coating material=parent material). The coating material was distributed over the topmost 50 mm of the blade, resulting in a coating thickness of 0.3 mm.
For checking, only some blades were now coated to begin with and the mass change and frequency change verified. The following values were obtained: dm=28.6 g, df=5.0 Hz.
On the basis of these measurement results, an additional mass of 32 g was then required and applied, so that the natural frequency change of 7 Hz was realized.

The method according to the invention is cost-effective and can be realized in a very short time. The flame spraying process is especially suitable, since “smooth” continuous transitions are thus created in the deposit thickness and the material 8 to be applied can be placed at the correct locations in a precisely localized manner without rework being necessary.

The invention is of course not restricted to the exemplary embodiment described.

List of designations
1 Blade
2 Airfoil
3 Blade root
4 Platform
5 Pressure side of item 2
6 Suction side of item 2
7 Trailing edge of item 2
8 Metallic coating
9 Blade tip of item 2
10 Leading edge of item 2

While the invention has been described in detail with reference to preferred embodiments thereof, it will be apparent to one skilled in the art that various changes can be made, and equivalents employed, without departing from the scope of the invention. Each of the aforementioned documents is incorporated by reference herein in its entirety.

1. A method of altering the frequency of blades, each blade formed of a parent material and includes an airfoil having a suction side, a pressure side, a leading edge, a trailing edge, and a blade tip, each blade including a blade root, the blades useful for thermal fluid-flow machines, the method comprising:
applying a metallic coating comprising a material identical to the parent material to the blade, said blade already ready for use, in the region of the blade tip, the thickness of the coating tapering continuously at the trailing edge and in the radial direction toward the blade root.

2. The method as claimed in claim 1, wherein applying the metallic coating comprises applying by flame spraying.

3. The method as claimed in claim 1, wherein the blades comprise turbine blades.
